(19) United States
(12) Patent Application Publication
(10) Pub. No.: US 2008/0061968 A1
(43) Pub. Date: Mar. 13, 2008

(54) System for and method of locating an object

(76) Inventor: Deborah A. Hollimon, Wellington, FL (US)

Correspondence Address: DAVID A. HILL, # 610, 825 East Evelyn Ave., Sunnyvale, CA, 94086, US

(21) Appl. No.: 11/901,166

(22) Filed: Sep. 13, 2007

Related U.S. Application Data
(60) Provisional application No. 60/844,322, filed on Sep. 13, 2006.

(51) Int. Cl. G08G 1/123; H04Q 7/00

(52) U.S. Cl. 340/539.32; 340/988

(57) ABSTRACT

A method of locating an object includes receiving a wireless signal and raising a marker above a surface of the object. The object can be a mobile vehicle, such as a car, a truck, a motor home, or a motorcycle. The marker can be a flag or a ball. In one embodiment, the marker is coupled to an end of a telescoping rod and is moved by extending the rod, by alternating extending and contracting the rod, by rotating the marker about an axis of the rod, or by any combination of these. Alternatively, or additionally, the marker is swung in a pendular motion above a surface of the object. In still another embodiment, movement of the marker is accompanied by an audio signal, such as chirping or any other distinctive sound.

### RELATED APPLICATION

This application claims priority under 35 U.S.C. §119(e) of the co-pending U.S. provisional patent application Ser. No. 60/844,322, filed Sep. 13, 2006, and titled “System for Locating a Vehicle,” which is hereby incorporated by reference.

### FIELD OF THE INVENTION

This invention relates to locating objects. More specifically, this invention relates to a system for and a method of locating objects such as automobiles in crowded locations.

### BACKGROUND OF THE INVENTION

With shopping center parking lots becoming more and more crowded, many shoppers find it difficult to locate their car after shopping. Many shoppers walk around the parking lots, trying to identify their car among similar looking ones. They activate their wireless electronic locks, hoping to hear the tell-tale chirp that sounds when a door is unlocked. This may be difficult when they are too far away from their car to hear the chirp or because the noise of parking lot activity drowns out the chirp. Discouraged shoppers waste their time and patience trying to locate a car that is often close by.

### SUMMARY OF THE INVENTION

Embodiments of the present invention provide a visual indication of the location of a car or other vehicle. In accordance with the present invention, a flag or other marker is attached to a telescoping element, such as an antenna. In response to a signal, such as that generated by a wireless transmitter, the telescoping element extends, thereby raising the flag. Owners are thus able to quickly locate their car, even above the din of parking lot activity. In other embodiments, a flag, ball, or other marker is repeatedly raised and lowered, rotated, oscillated, swung, or moved in other ways to catch the attention of the car's owner.

### BRIEF DESCRIPTION OF THE DRAWINGS

FIGS. 1A-G show a flag moved in response to an activation signal in accordance with the present invention.

FIGS. 2A-E also show a flag moved in response to an activation signal in accordance with the present invention.

FIG. 3 shows a ball moved in response to an activation signal in accordance with the present invention.

FIG. 4 also shows a ball moved in response to an activation signal in accordance with the present invention.

FIG. 5 is a phantom view of a mechanism for moving a flag in response to an activation signal in accordance with the present invention.

FIG. 6 shows a wireless transmitter in accordance with the present invention.

### DETAILED DESCRIPTION OF A PREFERRED EMBODIMENT

Embodiments of the present invention provide a visual indication of the location of a car or other vehicle. In accordance with the invention, a flag, ball, or other marker is moved in a way to alert a user of its location and thus the location of the car. Flags can be customized to suit a car owner's taste. They can be or can include a country flag, selected colors, tassels, ornaments, designs, logos (e.g., of a favorite football team), pictures, and the like.

It will be appreciated that while the examples below describe using the flag to locate a car, embodiments of the invention can be used to locate any type of vehicle in a crowded area. Other vehicles include, but are not limited to, trucks, motorcycles, motor homes, and recreational vehicles such as boats and snowmobiles.

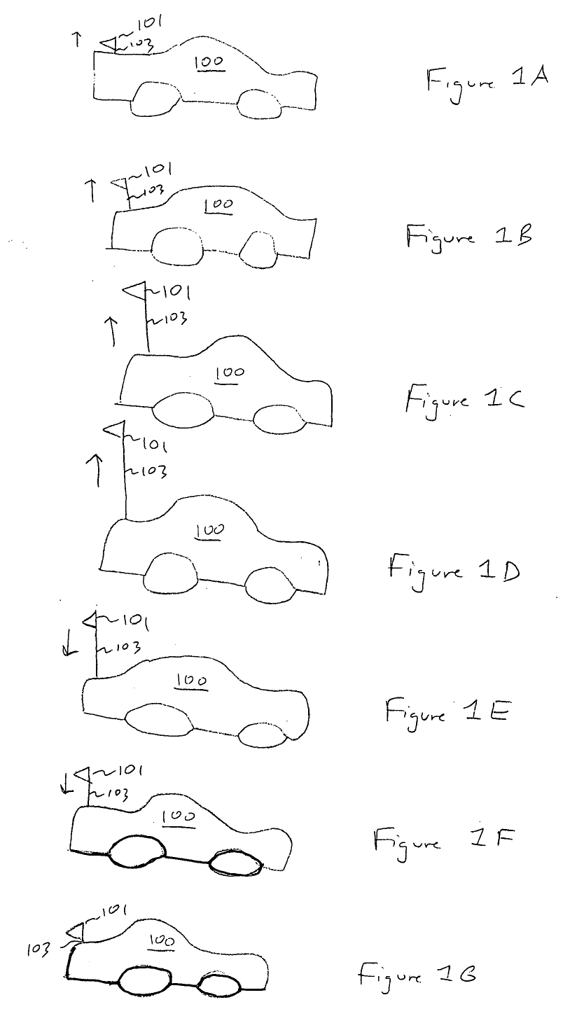

FIGS. 1A-G show a car 100 with a telescoping element 103 topped by a flag 101, in accordance with one embodiment of the present invention. In operation, a user searching a parking lot for her car 100 activates a wireless transmitter, such as one for unlocking the doors on her car, thereby generating a wireless activation signal. In response to the activation signal, the telescoping element 103 is extended, thereby raising the flag (FIGS. 1A-D) to a predetermined height over the roof of the car 100 and thus over the roofs of surrounding vehicles to provide a visual indication of the location of the car 100. As one example, the predetermined height is between 5 and 10 feet. Those skilled in the art will recognize that the predetermined height can be smaller than 5 feet, larger than 10 feet, or any height that allows a user to easily locate her car.

In other embodiments, in response to the activation signal, the telescoping element 103 raises the flag 101 (FIGS. 1A-D) and lowers the flag 101 (FIGS. 1E-F), repeating this cycle any number of times to catch the user's attention. In this way, if the user misses the raising of the flag 101, such as when her head is turned away from the flag 101, she can locate the flag 101 and thus her car 100 by the continuous movement of the flag 101.

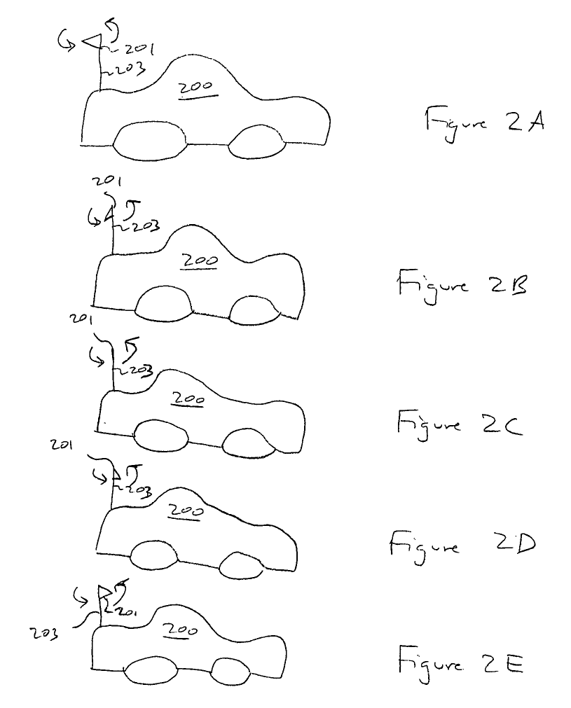

Those skilled in the art will recognize that flags and other markers can be moved in many predetermined ways to alert a user to the location of a car. FIGS. 2A-E, for example, show a pole 203 topped by a flag 201. As shown in the serial time sequences of FIGS. 2A-E, the pole 203 and thus the flag 201 is rotated about a central axis of the pole 203 to indicate the location of a car 200.

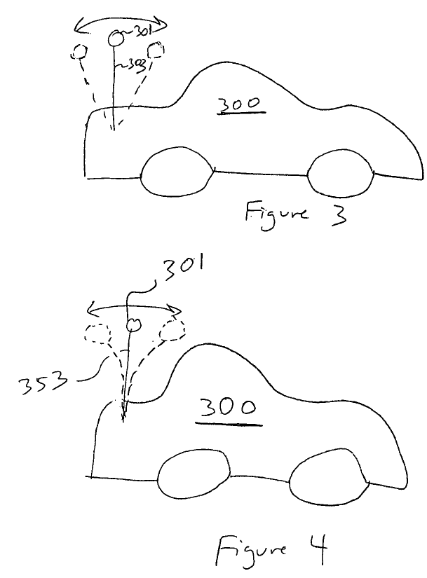

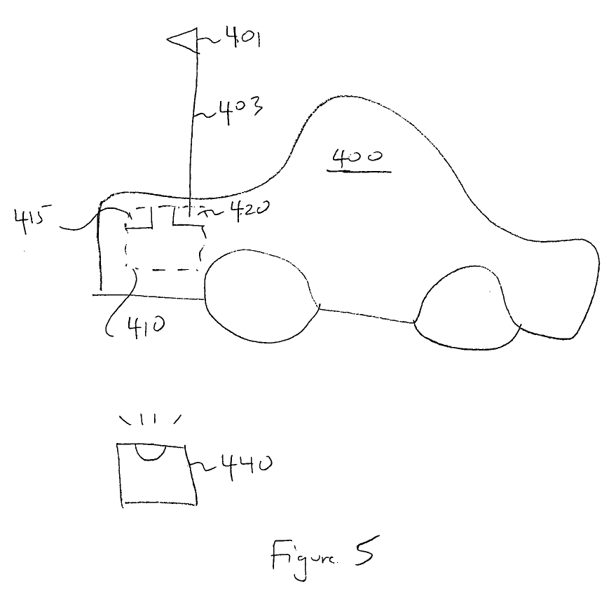

As another example, FIG. 3 shows a pole 303 topped by a ball 301 or other weighted object. In response to an activation signal, the pole 303 moves back and forth in an inverted pendular motion, as shown by the pole 303 and ball 301 in phantom. In this and other drawings, an element in phantom illustrates the element at different times. The pole 303 is rigid, so that it has a pendular motion. Alternatively, as shown in the illustration of FIG. 4, the ball 301 is attached to a flexible pole 353, made of a springy or elastic material. In this alternative embodiment, a small angular movement at the base of the pole 353 translates to a larger angular movement of the ball 301, as shown by the pole 353 and ball 301 in phantom. The weight of the ball 301 causes the pole 353 to spring back and forth. Such movement catches the user's attention, allowing her to easily locate her car. Of course, weighted objects other than a ball, as well as light objects such as a flag, can also top the flexible pole 353.

It will be appreciated that any of the movements discussed herein can be combined. For example, a flag can be raised and lowered as in FIGS. 1A-G and also rotated as shown in FIGS. 2A-E. These movements can be made sequentially or concurrently. In this embodiment, the pole to which the flag is attached rotates and also telescopes. It will also be appreciated that movement in accordance with the present invention can also be accompanied by sounds, such as chirping, beeping, or the honking of a horn, to provide additional location indicators to a person looking for her car.

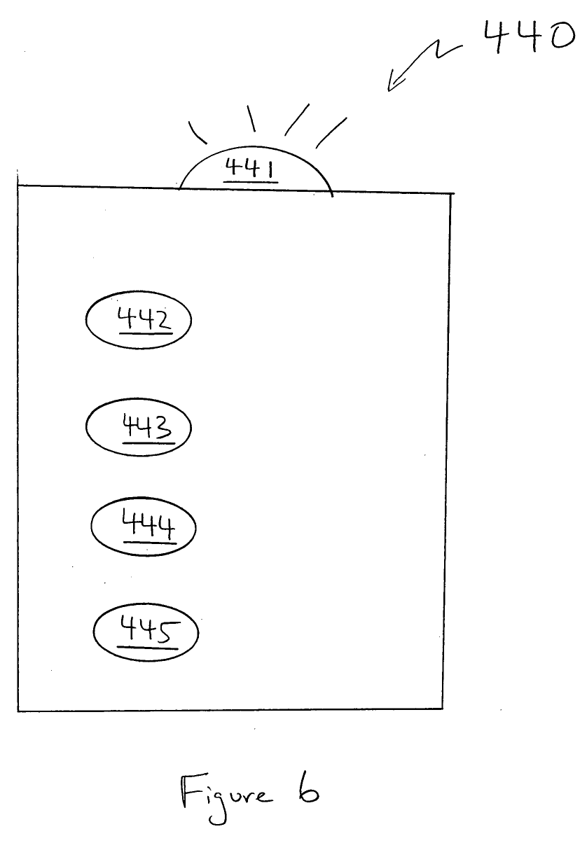

FIG. 5 illustrates a location module 410 installed on a car 400 in accordance with the present invention. The location module 410 includes a wireless receiver 415 coupled to a motor 420 that controls the movement of a pole 403 that supports a flag 401. The pole 403 can rotate, telescope, oscillate, or move in other ways that provide visual indications of the flag 401, such as described above.

While FIG. 5 shows the location module 410 coupled to a rear portion of the car 400, it will be appreciated that the location module 410 can be coupled to a front portion of the car 400, coupled to a roof of the car 400, or even distributed among multiple parts of the car (e.g., a motor in the trunk, a receiver and telescoping antennae on the roof). Indeed, the location module 410 can be positioned anywhere that allows it to receive an activation signal and move a marker in accordance with the present invention.

In operation, a user activates a wireless transmitter 440 that generates an activation signal received by the wireless receiver 415. In response to the activation signal, the motor 420 extends the pole 403, retracts the pole 403, rotates the pole 403, oscillates the pole 403, waves the pole 403, or performs any combination of these. In this way, the user is alerted to the location of the car 400.

Preferably, the pole 403 is a telescoping car antennae, though it can be a different element. Also, preferably, the wireless transmitter 440 is a key fob for unlocking the doors of the car 400. In one embodiment, the wireless transmitter 440 and elements of the door unlocking mechanism are configured so that the doors of the car 400 are not automatically unlocked by generating an activation signal. In this way, the doors are not unlocked when the user is far from the car 400, allowing uninvited persons to enter the car 400. After she reaches her car, the user can then unlock her car door using an activation signal different from the one used to control the location module 410. Using the wireless transmitter 440 or other mechanism, the user can also retract the pole 403 so that it can later be raised in accordance with the present invention.

FIG. 6 shows the wireless transmitter 440 in more detail, in accordance with one embodiment of the present invention. The transmitter 440 includes a transmitter window 441 for transmitting the wireless activation signal and buttons 442-445. Referring to FIGS. 5 and 6, the button 442 is used to unlock the doors of the car 400. The button 443 is used to activate the location module 410 (i.e., “locate a car”), as described above. The button 444 is used to retract the antennae 403, such as when the user has located the car 400 and thus wishes to “reset” the location module 410 for later use.

The button 445 is used to change the motion generated by the location module 410. For example, after the flag 401 has been extended using the button 443, pressing the button 445 once makes the flag 401 oscillate; pressing the button 445 again makes the flag 401 rotate about an axis of the antennae 403; pressing the button 445 again makes the flag 401 swing in a pendular motion; and pressing the button 445 once again once again makes the flag repeatedly move up and down while rotating. Movements can be combined in many ways in accordance with the present invention.

While the wireless transmitter 440 is shown with four buttons 442-445, it will be appreciated that wireless transmitters in accordance with the present invention can have more or fewer buttons, with corresponding more and less capabilities.

Wireless activation signals generated in accordance with the present invention can include radio frequency (RF) or infrared signals, to name only a few types of signals. RF signals can advantageously reflect off of cars and other objects in the vicinity of the receiver. RF signals can thus reach the receiver even though a direct signal path from the transmitter to the receiver is not available.

Embodiments of the present invention can be used in many different ways. For example, a raised or moving marker in accordance with the invention can be used to help identify a car in heavy traffic or from far distances, thereby allowing one driver to easily identify and thus follow another driver.

Embodiments of the present invention have a number of advantages. For example, some prior art systems use lights to identify an object. Those systems cannot be used in those areas that restrict raised lighting to police, safety, and emergency vehicles. Moreover, those systems are difficult to see and thus hard to locate in bright sunlight.

Embodiments of the present invention can also be used to locate objects other than mobile vehicles. As one example, the invention is used to mark an archeological, construction, or hard-to-locate site, such as those surrounded by bushes and other obstructions. Later, by using a moving marker in accordance with the present invention, the site can be quickly and easily located.

It will be readily apparent to one skilled in the art that other modifications may be made to the embodiments without departing from the spirit and scope of the invention as defined by the appended claims.

I claim:

1. A system comprising:
a module having a marker, wherein the module is configured to couple to an object and to move the marker in response to a wireless signal, to thereby locate the object; and
a receiver for receiving the wireless signal.

2. The system of claim 1, wherein the module is configured to raise the marker to a predetermined height above a surface of the object.

3. The system of claim 2, wherein the module comprises a telescoping element capped with the marker.

4. The system of claim 1, wherein the module is configured to rotate the marker about a predetermined axis, move the marker with a pendular motion, raise and lower the marker one or more times in a predetermined pattern, or any combination of these in response to receiving the wireless signal.

5. The system of claim 1, wherein the object is a mobile vehicle.

6. The system of claim 5, wherein the mobile vehicle is a car, a truck, a motorcycle, a motor home, or a recreational vehicle.

7. The system of claim 1, wherein the marker is a flag or a ball.

8. The system of claim 1, wherein the wireless signal is a radio frequency signal or an infrared signal.

9. A method of locating an object comprising:
receiving a wireless signal; and
moving a marker relative to a surface of the object in response to receiving the wireless signal.

10. The method of claim 9, wherein the object is a mobile vehicle.

11. The method of claim 10, wherein the mobile vehicle is moving.

12. The method of claim 10, wherein the mobile vehicle is stationary.

13. The method of claim 9, further comprising generating the wireless signal using a wireless transmitter.

14. The method of claim 9, wherein the wireless signal is a radio frequency signal or an infrared signal.

15. The method of claim 9, further comprising generating an audio signal at the object in response to receiving the wireless signal.

16. A system for locating a mobile vehicle comprising:
a transmitter for generating a wireless signal; and
a location module coupled to the mobile vehicle and comprising:
a receiver for receiving the wireless signal;
a rod with a marker attached thereto and coupled to the receiver; and
a mechanism configured to move the rod in a predetermined manner when the receiver receives the wireless signal.

17. The system of claim 16, wherein the marker is attached to an end of the rod.

18. The system of claim 16, wherein the predetermined manner is extending, repeatedly extending and contracting, rotating, swinging, or any combination of these.
